(19) United States
(12) Patent Application Publication
(10) Pub. No.: US 2023/0200965 A1
(43) Pub. Date: Jun. 29, 2023

(54) Protected Follicular Aspiration Device

(71) Applicant: WTA - Watanabe Tecnologia Aplicada Eireli, São Paulo (BR)

(72) Inventors: Osnir Yoshime WATANABE, São Paulo (BR); Ricardo Heitor BRENNER, Richland, WA (US)

(73) Assignee: WTA - Watanabe Tecnologia Aplicada Eireli, São Paulo (BR)

(21) Appl. No.: 17/926,537

(22) PCT Filed: Apr. 25, 2021
(86) PCT No.: PCT/BR2021/050172

§ 371 Date: Nov. 18, 2022

(30) Foreign Application Priority Data
May 20, 2020 (BR) BR 20 20200101175

(51) Int. Cl. A61D 19/00

(52) U.S. Cl. CPC A61D 19/00

(57) ABSTRACT

A protected follicular aspiration device containing a tube that protects the guide line providing enhanced sealing of the system, said device also having a sealing bung arrangement that forms a foam-retaining chamber preventing foam from entering the vacuum pump and a conical coupling between the guide line with the needle cannula and the sealing bung. The follicular aspiration device is intended for collecting follicles during an in vitro fertilization process, showing improvements in protecting and minimizing exposure of the collected material.

The present application claims priority under 35 U.S.C. § 365 to International Application No. PCT/BR2021/050172 filed on Apr. 25, 2021, and under 35 U.S.C. § 119 to Brazilian Application Number BR 20 2020 010117 5 filed on May 20, 2020.

### TECHNICAL FIELD

The present disclosure relates to a protected follicular aspiration device, in particular, containing a protective tube for the guide line reinforcing the sealing of the system, said device also has a sealing bung arrangement resulting in restraint for foam absorption by the vacuum pump and a conical coupling between the guide line with the needle cannula and sealing bung. Said follicular aspiration device is intended for the collection of follicles in an in vitro fertilization process, being improved to protect and minimize the exposure of the collected material.

### BACKGROUND OF THE ART

Follicles aspiration devices that are used together with an adapter for an ultrasound device and a vacuum motor for the suction of the material are widely known. In some cases, follicles are visualized in the ovary guided by an ultrasound and, in as precise and less traumatic way possible, they are collected by a needle and vacuum aspirated into a cell culture tube, being kept at the same temperature as the collected animal body in some heater device.

One drawback of the technique usually used is the transition from the follicle through the conductor to the cell culture tube due to the thickness of the guide line being very thin, it can occasionally bend, obstructing the material passage.

A second drawback with the prior art is the need for the guide line to be made of a very low friction coefficient material, thus creating an unfavorable condition for its fixation on the needle and on the aspiration bung, wherein commonly with the movement of the entire system during aspiration, the line is disconnected causing vacuum loss and interruption or loss of the process.

A third drawback of the follicle aspiration process is that when the material is deposited in the cell culture tube, it can generate foam, which, when aspirated, can damage the vacuum equipment used.

In view of the above, the Applicant has developed a device for follicular aspiration with a protection and sealing system to protect and minimize the exposure of the collected material.

### DESCRIPTION OF THE FIGURES

FIG. 1 is a perspective view of the device of at least one embodiment of the present invention;

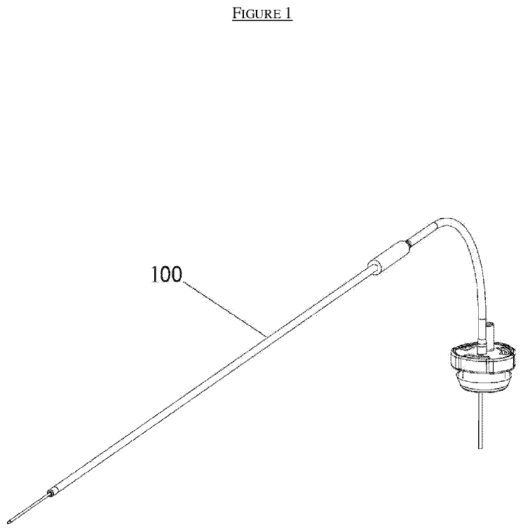

FIG. 2 is a detail side view showing how the protective tube is attached from the rod tube to the sealing bung;

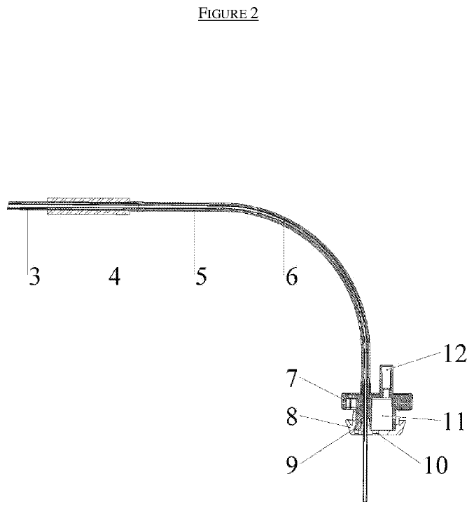

FIG. 3 is a detail side view showing the sealing bung fitted into a cell culture tube with representation of collected material and foam;

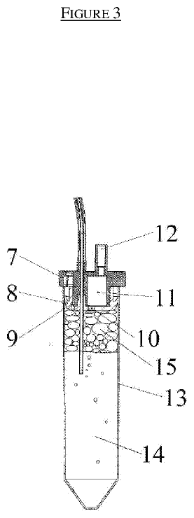

FIG. 4 is a detail sectional view showing the intermediate junction assembled to the needle cannula, rod tube and guide line;

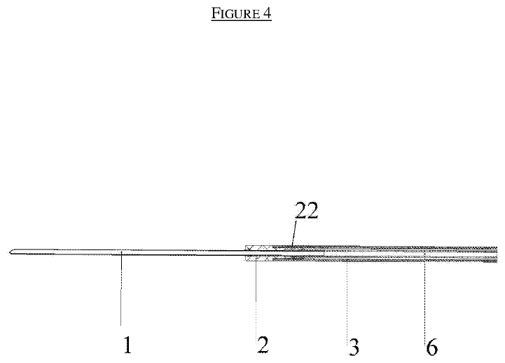

FIG. 5 is a bottom perspective detail view highlighting the sealing ring and vacuum hole of the sealing bung;

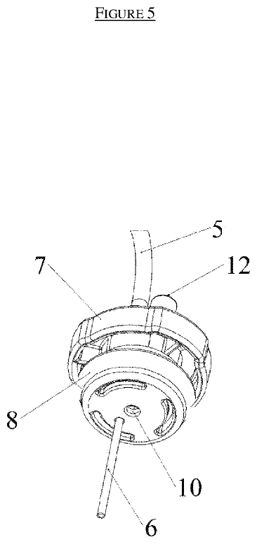

FIG. 6 is a detail exploded top perspective view highlighting the sealing flap and sealing ring fixing lock;

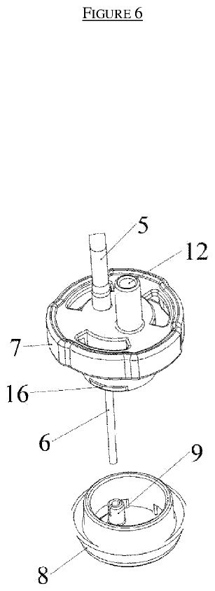

FIG. 7 is a bottom exploded perspective detail view highlighting the conical hole in the main body of the bung;

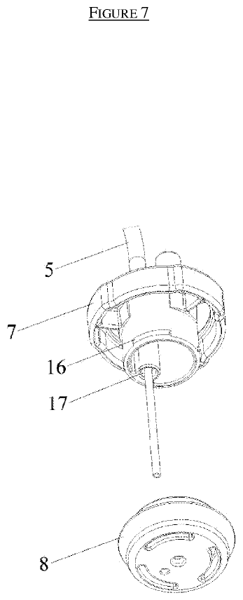

FIG. 8 is a representative illustration of the aspiration process;

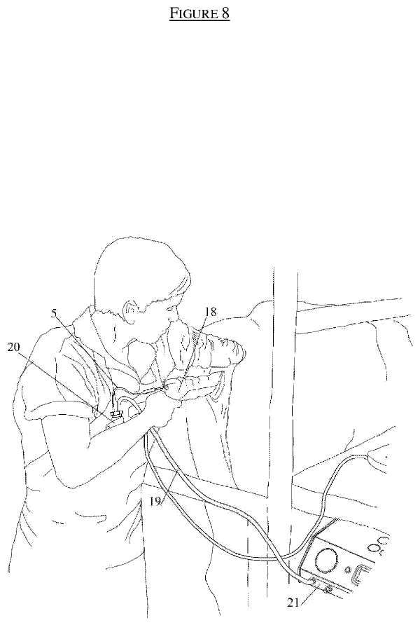

FIG. 9 is a side sectional view representing a variant used in dual-flow application.

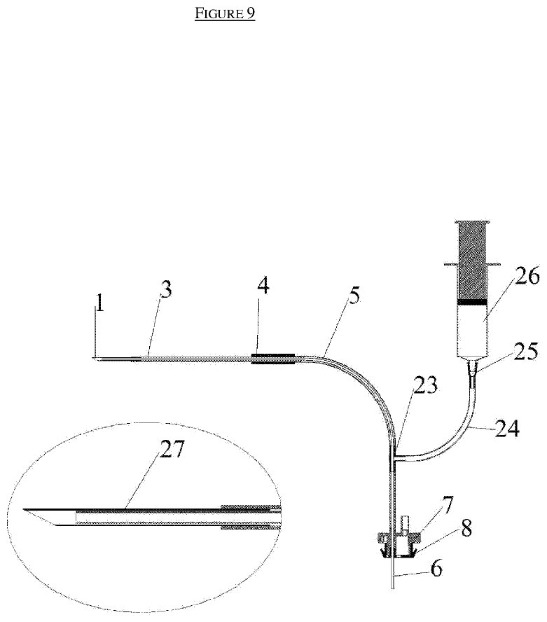

### BRIEF DESCRIPTION

The present disclosure is directed to a protected follicular aspiration device, in particular, containing a protective tube for the guide line reinforcing the sealing of the system, said device also has a sealing bung arrangement resulting in restraint for foam absorption by the vacuum pump and a conical coupling between the guide line with the needle cannula and sealing bung. Said follicular aspiration device is intended for the collection of follicles in an in vitro fertilization process, being improved to protect and minimize the exposure of the collected material.

Said conical coupling (22) between the guide line (6) with the needle cannula (1) and the sealing bung (7) is carried out in an intermediate junction (2) pressing the walls of the guide line (6) against the needle cannula (1), in the sealing bung (7) the line passes through a sealing flap and lock (9) coupled to the flexible sealing ring (8), which, when fitted in a conical hole (17) throttles the guide line (6) leaving it attached, the protective tube (5) of the guide line (6) is fixed directly on the sealing bung (7) and on the rod tube (3) of the aspiration device (100), creating with that a redundancy in the system sealing, preventing the vacuum loss even in a situation where the guide line (6) is detached from one of the ends.

At least one embodiment of the present invention solves the problem of the thickness and/or obstruction of the passage of the material through the presence of a protective tube (5) involving the entire exposure region.

Moreover, at least one embodiment of the present utility model application minimizes the problem of friction coefficient, vacuum loss and interruption or loss of the process since it has a containment with the sealing bung (7) itself, which forms a protection chamber (11), which is a space between the vacuum hole (10) and the connection of the vacuum hose (12), the foam bubbles touch the flexible sealing ring (8) but do not pass through the vacuum hole since they burst and run. A variant for this configuration is the addition of a T connection (23) on the protective tube (5), followed by a hose (24) and syringe connector (25), thus creating a second flow for applying liquids for washing.

### DETAILED DESCRIPTION

The protected follicular aspiration device of at least one embodiment of the present invention (100) comprises a needle cannula (1) coupled to an intermediate junction (2) consisting of a plastic part with a conical coupling (22) where it is attached by mechanical interference to guide line (6), this is being pressed on the wall of the needle cannula (1) where it is superimposed, the intermediate joint (2) is fitted and welded inside a rod tube (3) made of a polymeric material with greater rigidity, this receives at the other end a handling handle (4) and still connected directly to the rod tube (3) is the protective tube (5), through which the guide line (6) passes internally and continues passing through the sealing bung (7) main body wherein it is held by constriction by the sealing and lock flap (9), which, being made of flexible material, when pressed in the conical hole (17) closes against the walls of the guide line (6). The protective tube (5) which is connected at one end to the rod tube (3) and at the other end to the main body of the sealing bung (7), thus providing insulation between the entire system.

At the main body of the sealing bung (7), the flexible sealing ring (8) fits with interference, which is permanently fixed due to the fixing look (16), and it is in this assembly process that the sealing and lock flap (9) is fitted in the conical hole (17) with the guide line (6) passing between them, this flexible sealing ring (8) has a vacuum hole (10), a small hole that gives passage to a protection chamber (11) followed by a vacuum hose connection profile (12).

A variant for this embodiment consists of a needle cannula (1) fixed directly to a rod tube (3) where the manipulation handle (4) fits and directly to the rod tube itself (3) the protective tube (5) is connected (5) that goes to the sealing bung (7) passing through an interruption by a T connection (23) that leads to a hose (24) with a connector (25) where a syringe (26) is fitted for the application of liquids that pass through the ends (27) that are between the guide line (6) with the protective tube (5), the rod tube (3) and the needle cannula (1).

Operation Mode

An aspiration guide (18) assisted by an ultrasound device is introduced into the animal's vagina and placed against the ovary walls to locate the follicles, the needle cannula (1) is introduced and aspiration is started through a vacuum device (21) which is connected to the vacuum hose connection profile (12) through the hose (19). The internal pressure of the cell culture tube (13) becomes negative and drags the collected material into the needle cannula (1) and passing through the guide line (6), where it moves dragged by the vacuum until it reaches the cell culture tube (13) which is being heated by a heating device (20), the protective tube (5) protects the guide line (6) from possible bending that may occur in any movement of the user during the aspiration process. As it has a larger diameter and more resistant material this protective tube (5) receives all the mechanical action directly on it maintaining the integrity of the guide line (6).

The material deposited (14) in the cell culture tube (13) often generates an unwanted foam (15), which in turn is contained by the flexible sealing ring (8) which has only a vacuum hole (10) for security preventing the foam (15) from reaching the vacuum hose connection profile (12) in order to avoid suction to the vacuum device (21).

In the double-flow embodiment variant, the aspiration process is the same, with the differential being the possibility of injecting liquid through the ends (27) by connecting a syringe (26) to the system. This injected liquid is aspirated and then enters through the guide line (6).

1-3. (canceled)

4. A protected follicular aspiration device, comprising a protective tube for the guide line, a sealing bung arrangement and a conical coupling between the guide line with the needle cannula and sealing bung, a protection chamber and a flexible sealing ring with fixing locks, wherein said conical coupling between the conducting line with the needle cannula and the sealing bung comprises an intermediate junction, wherein said follicular aspiration device is intended for collecting follicles during an in vitro fertilization process.

5. The device according to claim 4, characterized in that it additionally comprises a sealing and locking flap, a conical hole, a rod tube, a vacuum hose and a handling handle.

6. The device according to claim 4, characterized in that it additionally comprises a T connection leading to a hose with a connector wherein a syringe is fitted.
